(19) United States
(12) Patent Application Publication
(10) Pub. No.: US 2018/0154233 A1
(43) Pub. Date: Jun. 7, 2018

(54) ILLUMINATED TOSS GAME SYSTEM

(71) Applicants: David Mueller, Brownwood, TX (US); Dan Spiller, Joshua, TX (US)

(72) Inventors: David Mueller, Brownwood, TX (US); Dan Spiller, Joshua, TX (US)

(21) Appl. No.: 15/832,660

(22) Filed: Dec. 5, 2017

Related U.S. Application Data
(60) Provisional application No. 62/430,328, filed on Dec. 5, 2016.

(51) Int. Cl. A63B 67/06; A63B 71/06; F21V 33/00; F21V 23/00; F21V 23/02

(52) U.S. Cl. CPC A63B 67/06; A63B 71/0605; F21V 33/008; F21V 23/003; A63B 2071/0694; A63B 2067/061; A63B 2207/02; A63B 2209/00; F21V 23/02

(57) ABSTRACT

An illuminated toss game system including a pair of cups each having a body, an inner volume, an open end, and a base, and a pair of inserts, an illuminator, and a powerer. The pair of inserts include a puck-like profile and each have an illuminator which is configured to be positioned within the pair of cups and provide illumination when activated. The pair of cups may be placed below a ground surface within a recess and be used for playing an illuminated toss game and receiving game pieces.

### CROSS REFERENCE TO RELATED APPLICATION

The present application is related to and claims priority to U.S. Provisional Patent Application No. 62/430,328 filed Dec. 5, 2016, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of games and more specifically relates to toss games.

### 2. Description of Related Art

Many people enjoy playing games. A game is structured form of play, usually undertaken for enjoyment and sometimes used as an educational tool. Key components of games are goals, rules, challenge, and interaction. Games generally involve mental or physical stimulation, sometimes simultaneously. Games are a universal part of human experience and present in all cultures. Certain parts of games, especially those played outdoors, become hard to see during dusk and nighttime hours, forcing players to quit by a certain hour. This can be frustrating and inconvenient for players, especially those with a fun, competitive nature that enjoy not only playing but practicing in the evenings. A suitable solution is desired.

U.S. Pat. No. 7,854,528 to Perry J. Segretto relates to an illumination apparatus for bag toss game. The described illumination apparatus for bag toss game includes a light array for illuminating the circular opening in the platform of a bag toss game includes a circular frame and mating cover that define a hole, at least equal in area to the opening. A plurality of lights (LEDs) is positioned in the annular enclosure formed by the frame and cover. The cover includes a transparent wall through which light is projected to the opening in the platform. An annular printed circuit board is supported in the annular enclosure and mechanically supports and electrically connects the LEDs to a switched battery source. Different embodiments for blinking and sequencing the LEDs are shown. A laser diode arrangement for producing a cross hair pattern of beams in the platform hole is also described.

### BRIEF SUMMARY OF THE INVENTION

In view of the foregoing disadvantages inherent in the known games art, the present disclosure provides a novel illuminated toss game system. The general purpose of the present disclosure, which will be described subsequently in greater detail, is to provide an illuminated toss game for use with a variety of toss games.

An illuminated toss game system is disclosed herein. The illuminated toss game system includes a pair of cups each having a body, an inner volume, an open end, and a base, and a pair of inserts, an illuminator, and a powerer. The pair of cups each comprise an elongated cylindrical body having the inner volume, the open end, and the base. The pair of inserts comprises the illuminator and the powered. The pair of inserts each having the illuminator is configured to be positioned within the pair of cups and provide illumination when activated. The illuminator is powered by the powerer and activated by a controller. The pair of cups are configured to be placed below a ground surface within a recess and be used for playing a toss game and receiving game pieces.

A kit is also disclosed herein including a pair of cups, game pieces, a set of instructions.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an illuminated toss game system and method, constructed and operative according to the teachings of the present disclosure.

FIG. 1 is a perspective view of the illuminated toss game system during an ‘in-use’ condition, according to an embodiment of the disclosure.

FIG. 2 is a perspective view of the illuminated toss game system of FIG. 1, according to an embodiment of the present disclosure.

FIG. 3 is a perspective view of the illuminated toss game system of FIG. 1, according to an embodiment of the present disclosure.

FIG. 4 is a perspective view of the illuminated toss game system of FIG. 1, according to an embodiment of the present disclosure.

FIG. 5 is a perspective view of the illuminated toss game system of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to games and more particularly to an illuminated toss game system as used to improve toss games played.

Generally, illuminated toss game system is a washer cup that can be used during the day but comes to life at night with the touch of a button, providing a lighted target for players. This innovative product may be comprised of a section of cast acrylic or like material that is impact resistant and transmits light. The material can be in assorted colors diameters or lengths, to accommodate diverse washer toss games played around the world. The acrylic can be cut to a desired length and a cap/cover, with drain holes, and or connection ports can be affixed to one end to create the base of the cup. If the cup is to be personalized, the images (i.e. name, sports team etc.) can be added to the outside of the cup, in a mirror image, so that it can be seen from inside the cup. The outer acrylic can then be covered with a PVC coating (heat shrink) or like material, ranging from chrome or reflective film to any desired color that reflects light.

Furthermore, once the first initial color or reflective material has been affixed to the cup, any number of PVC coatings (heat-shrink) or like material can be added to personalize the cup on the exterior. A “puck,” constructed of acrylic, PVC or other suitable materials, containing any type of lights single/multicolor, batteries, connection for external power, and controller can then be inserted in connected to the cup. The top of the light assembly, or the “puck,” can then be covered with impact-resistant material, which can be clear or customized to any array of colors. The puck can then be inserted and removed from a cup as desired for service or storage. The cup's color or brightness and or activities can be controlled locally or by remote, depending on desired control method. The cups have many methods of operation for color from stationary to auto transition ranging from a slow fade to strobing. The cup can also be setup to change colors or strobe from the impact of washers. The exact specifications may vary upon manufacturing.

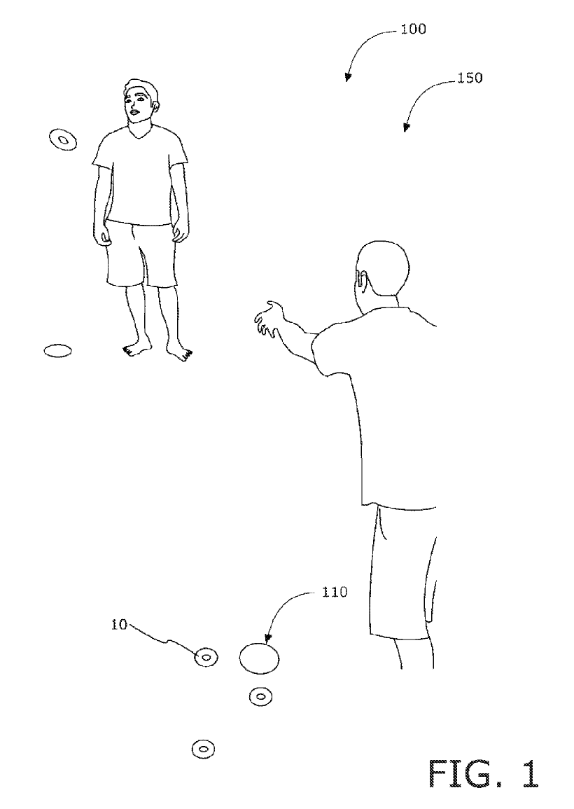

Referring now more specifically to the drawings by numerals of reference, there is shown in FIGS. 1-5, various views of an illuminated toss game system 100. FIG. 1 shows an illuminated toss game system 100 during an ‘in-use’ condition 150, according to an embodiment of the present disclosure. As illustrated, the illuminated toss game system 100 may include a pair of cups 110 each having a body 111, an inner volume 112, an open end 114, and a base 116, and a pair of inserts 120, an illuminator 122, and a powerer. The present invention provides a lighted target for players during toss games.

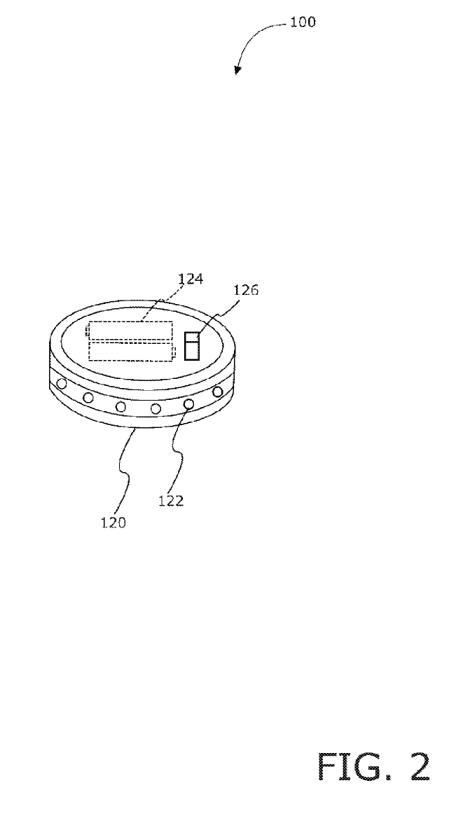

FIG. 2 shows a perspective view of the illuminated toss game system 100 of FIG. 1, according to an embodiment of the present disclosure. As above, the illuminated toss game system 100 may include the pair of cups 110 and the pair of inserts 120. The pair of cups 110 each comprise an elongated cylindrical body 111 having the inner volume 112, the open end 114, and the base 116. The pair of inserts comprises the illuminator 122 and the powered 124. The pair of inserts 120 each having the illuminator 122 configured to be positioned within the pair of cups 110 and provide illumination when activated. The illuminator 122 is powered by the powerer 124 and activated by a controller 126. The pair of cups 110 are configured to be placed below a ground surface within a recess and be used for playing a toss game and receiving game pieces 10.

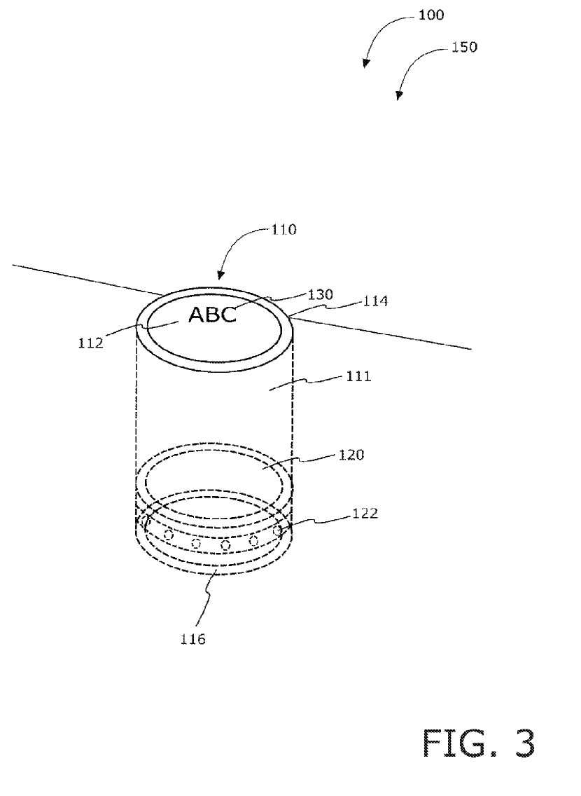

Referring now to FIG. 3 showing a perspective view of the illuminated toss game system 100 of FIG. 1, according to an embodiment of the present disclosure. As above, the illuminated toss game system 100 may include the pair of cups 110 each having the body 111, the inner volume 112, the open end 114, and the base 116, and the pair of inserts 120, the illuminator 122, and the powered 124. The body 111 comprises material configured to transmit light. The base 116 further comprises an end-cap having a series of drainage apertures. The controller 126 may be local or remote to the pair of cups 110. A button may be included for activating the illuminator 122. The illuminator 122 preferably comprises a plurality of customizable lights. The powerer 124 may include batteries or an external power source for charging.

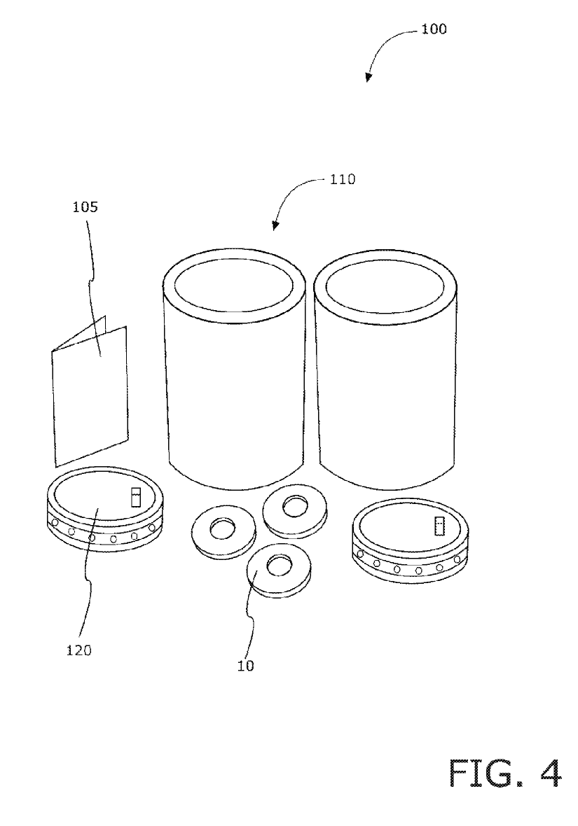

FIG. 4 shows a perspective view of the illuminated toss game system 100 of FIG. 1, according to an embodiment of the present disclosure. As above, the illuminated toss game system 100 may include the pair of cups 110 and the pair of inserts 120. The pair of inserts 120 are configured to be inserted into the inner volume 112 of the pair of cups 110 and provide illumination when the illuminator is activated and the powerer 124 has a charge. The pair of inserts 120 are removeable from the inner volume 112 of the pair of cups 110. The pair of inserts 120 comprise a substantially similar cylindrical profile to the pair of cups 110 such that the pair of inserts 120 may be inserted into a bottom portion of the pair of cups 110. The pair of inserts 120 include a puck-like profile. The pair of inserts 120 may house the powered 124. The plurality of customizable lights are disposed on an outer edge of the pair of inserts 120. In certain embodiments, the pair of inserts are transparent.

The pair of cups 110 may further comprise indicia 130. The indicia 130 may be in a mirrored image on an outer-surface and can be viewed on an inner-surface of the body 111 of the pair of cups 110. The pair of cups 110 comprise impact resistant material and may be reflective.

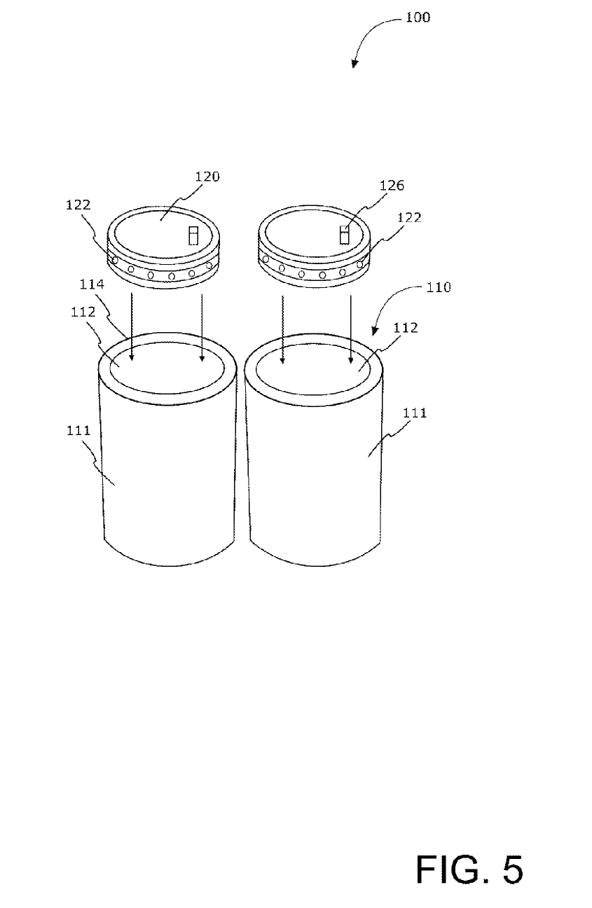

FIG. 5 shows a perspective view of the illuminated toss game system 100 of FIG. 1, according to an embodiment of the present disclosure. According to one embodiment, the illuminated toss game system 100 may be arranged as a kit. The kit may include a pair of cups 110, game pieces 10, a set of instructions 105. The instructions may detail functional relationships in relation to the structure of the illuminated toss game system 100 (such that the illuminated toss game system 100 can be used, maintained, or the like, in a preferred manner).

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An illuminated toss game system comprising:
a pair of cups each having;
a body;
an inner volume;
an open end; and
a base; and
a pair of inserts;
an illuminator; and
a powerer;
wherein said pair of cups each comprise an elongated cylindrical body having said inner volume, said open end, and said base;
wherein said pair of inserts comprises said illuminator and said powerer;
wherein said pair of inserts each having said illuminator is configured to be positioned within said pair of cups and provide illumination when activated;
wherein said illuminator is powered by said powerer and activated by a controller; and
wherein said pair of cups are configured to be placed below a ground surface within a recess and be used for playing a toss game and receiving game pieces.

2. The illuminated toss game system of claim 1, wherein said base further comprises an end-cap.

3. The illuminated toss game system of claim 2, wherein said end-cap comprises drainage apertures.

4. The illuminated toss game system of claim 1, wherein said controller is configured locally to said pair of cups.

5. The illuminated toss game system of claim 1, wherein said controller is configured remotely to said pair of cups.

6. The illuminated toss game system of claim 1, wherein said pair of inserts are removeable from said inner volume of said pair of cups.

7. The illuminated toss game system of claim 6, wherein said pair of inserts are configured to be inserted into said inner volume of said pair of cups and provide illumination when said illuminator is activated and said powerer has a charge.

8. The illuminated toss game system of claim 6, wherein said pair of inserts house said powerer.

9. The illuminated toss game system of claim 6, wherein said illuminator comprises a plurality of customizable lights.

10. The illuminated toss game system of claim 1, wherein said powerer comprises batteries.

11. The illuminated toss game system of claim 1, wherein said powerer is externally powered.

12. The illuminated toss game system of claim 1, wherein said body comprises material configured to transmit light.

13. The illuminated toss game system of claim 1, wherein said pair of cups comprise indicia.

14. The illuminated toss game system of claim 13, wherein said indicia is in a mirrored image on an outer-surface and can be viewed on an inner-surface of said body of said pair of cups.

15. The illuminated toss game system of claim 1, wherein said pair of cups comprise impact resistant material.

16. The illuminated toss game system of claim 1, wherein said pair of cups are reflective.

17. The illuminated toss game system of claim 1, wherein said pair of inserts are transparent.

18. The illuminated toss game system of claim 1, wherein said plurality of customizable lights are disposed on an outer edge of said pair of inserts.

19. An illuminated toss game system comprising:
a pair of cups each having;
a body;
an inner volume;
an open end; and
a base; and
a pair of inserts;
an illuminator; and
a powerer;
wherein said pair of cups each comprise an elongated cylindrical body having said inner volume, said open end, and said base;
wherein said body comprises material configured to transmit light;
wherein said pair of cups comprise indicia;
wherein said pair of cups comprise impact resistant material;
wherein said pair of inserts comprises said illuminator and said powerer;
wherein said pair of inserts each having said illuminator is configured to be positioned within said pair of cups and provide illumination when activated;
wherein said illuminator is powered by said powerer and activated by a controller;
wherein said base further comprises an end-cap;
wherein said end-cap comprises drainage apertures;
wherein said controller is configured locally to said pair of cups;
wherein said pair of inserts are removeable from said inner volume of said pair of cups;
wherein said pair of inserts are transparent;
wherein said pair of inserts are configured to be inserted into said inner volume of said pair of cups and provide illumination when said illuminator is activated and said powerer has a charge;
wherein said pair of inserts house said powerer;
wherein said illuminator comprises a plurality of customizable lights;
wherein said plurality of customizable lights are disposed on an outer edge of said pair of inserts;
wherein said powerer comprises batteries; and
wherein said pair of cups are configured to be placed below a ground surface within a recess and be used for playing a toss game and receiving game pieces.

20. The illuminated toss game system of claim 19, further comprising a pair of cups, game pieces, a set of instructions; and
wherein the illuminated toss game system is arranged as a kit.
